(19) United States
(12) Patent Application Publication
(10) Pub. No.: US 2009/0022138 A1
(43) Pub. Date: Jan. 22, 2009

(54) MULTIPLEXING PROTOCOL FOR LARGE, HIGH SECURITY AREAS WITH 3D LOCALIZATION

(75) Inventors: Rod Gilchrist, Oakville (CA); John K. Stevens, Stratham, NH (US); Florin Tarcoci, Cornwall (CA); Paul Waterhouse, Copetown (CA)

Correspondence Address: MICHAEL J. BUCHENHORNER, 8540 S.W. 83 STREET, MIAMI, FL, 33143, US

(73) Assignee: Visible Assets Inc., Mississauga (CA)

(21) Appl. No.: 11/943,469

(22) Filed: Nov. 20, 2007

Related U.S. Application Data
(60) Provisional application No. 60/860,322, filed on Nov. 20, 2006.

(51) Int. Cl. H04J 3/06

(52) U.S. Cl. 370/350

(57) ABSTRACT

A method for providing unlimited multiplexing of network nodes includes steps of: placing a plurality of tags within a network node, wherein the tags comprise the RuBee long wavelength network protocol; clipping the plurality of tags into separate areas for transmitting and receiving, by placing a plurality of base stations within the network node such that at least one base station overlaps with an adjacent network node; and synchronizing transmit packets from two adjacent base stations transmitting at a same time, such that the tags detect and respond to the packets from a nearby base station and perceive the packets from the distant base station as noise.

### CROSS-REFERENCE TO RELATED APPLICATIONS

This application is a non-provisional of U.S. application Ser. No. 60/860,322, filed on Nov. 20, 2006 and incorporated by reference in its entirety herein. This application contains inventive material similar to and related to that contained in co-pending application Ser. No. 11/754,261, “Secure, Networked Portable Storage Device,” filed May 25, 2007; and co-pending application Ser. No. 11/735,959, “Networked Tags for Tracking Animals” filed Apr. 16, 2007.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### TRADEMARKS

RuBee™ is a registered trademark of Visible Assets, Inc. of the United States. Other names used herein may be registered trademarks, trademarks or product names of Visible Assets, Inc. or other companies.

### FIELD OF THE INVENTION

The invention disclosed broadly relates to the field of transmission protocols and more particularly relates to a multiplexing protocol for large, high security areas.

### BACKGROUND OF THE INVENTION

The Visible Assets, Inc. (VAI) RuBee™ IEEE P1902.1 protocol (hereinafter “RuBee™”) is a long wavelength (LW), inductive, ultra low-power, two-way transceiver radio tag communication protocol. RuBee was designed to work reliably over a long range, wide area (one to one hundred feet), and in harsh environments (e.g., near metals and liquids), with an extended battery life (10-15 years) and a safety standard consistent for use in any healthcare application. RuBee™'s design goal was to create a low cost two-way radio tag that could be safely used in hospital patient-based settings, with no electromagnetic interference (EMI) or electromagnetic compatibility (EMC) issues and high data reliability.

The RuBee™ protocol uses a 131 kHz data carrier in transceiver mode. The long wavelength produces little, if any, energy in the form of an electric field (E). Most radiated energy (99.99%) is in the form of a magnetic field (H). A typical RuBee tag produces about 100 mGauss of magnetic signal strength and a few (one to five) nanowatts of electric field. A typical RuBee™ base station produces 500-800 mGauss of magnetic field and about 40-50 nanowatts of electric field. To provide some context for these values, the earth's magnetic field is 300-600 mGauss. A RuBee™ radio tag needs a minimum signal of 0.1 mGauss of field strength for reliable communication. Thus, the range limits are set by the emitted magnetic field strength from the tag to the antenna, not the field strength from the antenna to the tag. While the range may be increased by increasing the power to the tag's antenna, this may reduce battery life. It is also possible to increase the range and power by increasing the size of the tag's antenna.

Most asset visibility networks require constant polling or interrogation and rapid interaction with the base station and tags. RuBee™, however, has many advantages (works in harsh environments, long battery life, water immunity, controlled range, steel-friendly) because it uses low frequency carriers (typically 131 kHz) and has a baud rate of 1,200. Any reduction in throughput is not acceptable. Known transmission methods lead to serious reduction in this baud rate and are limiting.

Therefore, there is a need for a method of multiplexing adjacent antennas with overlap in order to overcome the shortcomings of the known art.

### SUMMARY OF THE INVENTION

Briefly, according to an embodiment of the invention a method for providing unlimited multiplexing of network nodes includes steps of: placing a plurality of tags within a network node, wherein the tags comprise the RuBee™ long wavelength network protocol; clipping the plurality of tags into separate areas for transmitting and receiving, by placing a plurality of base stations within the network node such that at least one base station overlaps with an adjacent network node; and synchronizing transmit packets from two adjacent base stations transmitting at a same time, such that the tags detect and respond to the packets from a nearby base station and perceive the packets from the distant base station as noise.

According to another embodiment of the invention, a multiplexed network of nodes includes: a plurality of tags placed within a network node; a plurality of base stations placed such that at least one base station overlaps with an adjacent network node; and transmit packets synchronized with adjacent base stations. The network node configuration may be linear, circular, or some other topography. A network node may itself be network of nodes.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 shows a Clip study set up, according to an embodiment of the present invention;

FIG. 2 shows Clip study images, according to an embodiment of the present invention;

FIG. 3 shows a base station where A and B are synchronized; according to the known art;

FIG. 4 shows a base station where A and B are not synchronized, according to the known art;

FIG. 5 shows a base station where A and B are clipped, according to an embodiment of the present invention;

FIG. 6 shows Clip mode fields;

FIG. 7 shows Clip mode magnetic fields;

FIG. 8 shows a linear Clipped RuBee™ antenna farm;

FIG. 9 shows a RuBee™/Clipped 3D Localization Visibility network;

FIG. 10 shows a RuBee™/Clipped High Security Configuration;

FIG. 11 shows a graph of predicted signal to noise ratio;

FIG. 12 is an illustration of acceptable Clip jitter;

FIG. 13 shows the token method with two base stations talking when the other is not talking, according to the known art;

FIG. 14 shows two base stations unsynchronized and colliding, according to the known art; and

FIG. 15 shows the Clip multiplex protocol method with two base stations talking while synchronized with each other, according to an embodiment of the present invention.

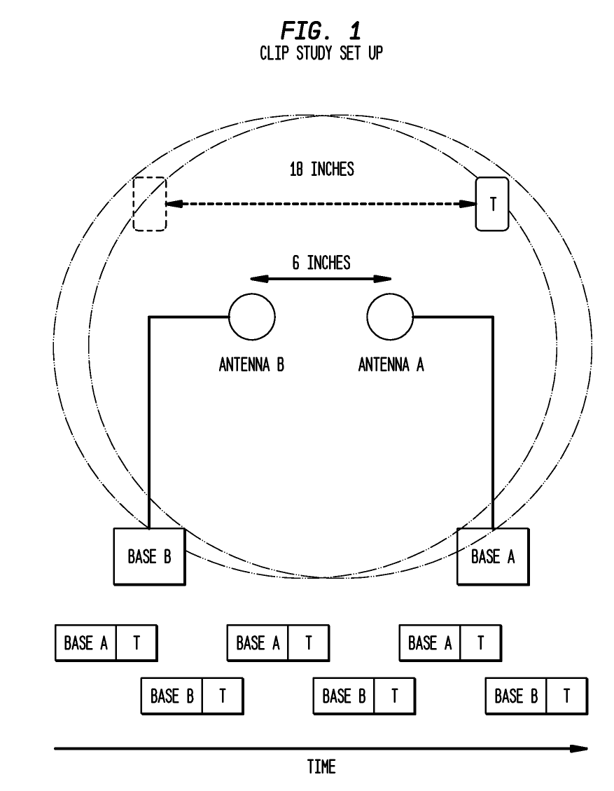

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

### The Clip Protocol

We describe a new counterintuitive multiplexing scheme referred to as the Clip protocol in this document. The method provides for unlimited multiplexing of adjacent high security networks within a network, as well as optional 3D (three dimensional) localization between networks. The protocol depends upon the fact that RuBee is a near-field inductive system and the signal strength decreases 1/R³. If the transmit packets from two adjacent antennas are synchronized so they both transmit at the same time, the signal strength at a tag from one base station is sufficient enough so that the tag will sync up and read on one base station. The tag will respond (depending upon the instruction) with a packet that may be read by both, or in many cases, also read by only one. The synchronization does not have to be precise and can be done using a TCP/IP or UDP network-based system. The RuBee™ tags will detect one base as a signal and the second as noise. Clip does decrease the signal-to-noise ratio a bit, however not enough to affect read/write tag speed or performance. Since Clip relies on the RuBee™ tag technology, some background on RuBee™ is presented here:

### RuBee™ Tag Technology

Radio tags communicate via magnetic (inductive communication) or electric radio communication to a base station or reader, or to another radio tag. A RuBee™ radio tag works through water and other bodily fluids, and near steel, with an eight to fifteen foot range, a five to ten-year battery life, and three million reads/writes. It operates at 132 kHz and is a full on-demand peer-to-peer, radiating transceiver.

RuBee™ is a bidirectional, on-demand, peer-to-peer transceiver protocol operating at wavelengths below 450 kHz (low frequency). A transceiver is a radiating radio tag that actively receives digital data and actively transmits data by providing power to an antenna. A transceiver may be active or passive.

Low frequency (LF), active radiating transceiver tags are especially useful for visibility and for tracking both inanimate and animate objects with large area loop antennas over other more expensive active radiating transponder high frequency (HF)/ultra high frequency (UHF) tags. These LF tags function well in harsh environments, near water and steel, and may have full two-way digital communications protocol, digital static memory and optional processing ability, sensors with memory, and ranges of up to 100 feet. The active radiating transceiver tags can be far less costly than other active transceiver tags (many under one US dollar), and often less costly than passive back-scattered transponder RFID tags, especially those that require memory and make use of an EEPROM. With an optional on-board crystal, these low frequency radiating transceiver tags also provide a high level of security by providing a date-time stamp, making full AES (Advanced Encryption Standard) encryption and one-time pad ciphers possible.

One of the advantages of the RuBee™ tags is that they can receive and transmit well through water and near steel. This is because RuBee™ operates at a low frequency. Low frequency radio tags are immune to nulls often found near steel and liquids, as in high frequency and ultra high-frequency tags. This makes them ideally suited for use in office environments where metal is commonly used in shelving and in construction. Fluids have also posed significant problems for current tags. The RuBee™ tag works well through water. In fact, tests have shown that the RuBee™ tags work well even when fully submerged in water. This is not true for any frequency above 1 MHz. Radio signals in the 13.56 MHz range have losses of over 50% in signal strength as a result of water, and anything over 30 MHz have losses of 99%.

Another advantage is that RuBee™ tags can be networked. One tag is operable to send and receive radio signals from another tag within the network or to a reader. The reader itself is operable to receive signals from all of the tags within the network. These networks operate at long-wavelengths and accommodate low-cost radio tags at ranges to 100 feet. The standard, IEEE P1902.1™, “RuBee Standard for Long Wavelength Network Protocol”, allows for networks encompassing thousands of radio tags operating below 450 kHz.

The inductive mode of the RuBee™ tag uses low frequencies, 3-30 kHz VLF or the Myriametric frequency range, 30-300 kHz LF in the Kilometric range, with some in the 300-3000 kHz MF or Hectometric range (usually under 450 kHz). Since the wavelength is so long at these low frequencies, over 99% of the radiated energy is magnetic, as opposed to a radiated electric field. Because most of the energy is magnetic, antennas are significantly (10 to 1000 times) smaller than ¼ wavelength or 1/10 wavelength, which would be required to efficiently radiate an electrical field. This is the preferred mode.

As opposed to the inductive mode radiation above, the electromagnetic mode uses frequencies above 3000 kHz in the Hectometric range, typically 8-900 MHz, where the majority of the radiated energy generated or detected may come from the electric field, and a ¼ or 1/10 wavelength antenna or design is often possible and utilized. The majority of radiated and detected energy is an electric field.

RuBee™ tags are also programmable, unlike RFID tags. The RuBee™ tags may be programmed with additional data and processing capabilities to allow them to respond to sensor-detected events and to other tags within a network.

### Methods

We report test results of a recently discovered variation of the RuBee™ protocol for multiplexing adjacent base stations known as Clip synchronization. Because the data communication is 100% inductive, a RuBee™ antenna reads/writes within a sphere surrounding (all axes). A RuBee™ antenna typically reads a co-planer tag inside the loop as well as outside the loop (the Overlap Region). The Overlap Region varies with antenna size. The Overlap Region for small loops (12″ to 36″) has spherical read/write distances of 10-15 feet or near 1,000%. Loops with a diameter of 8 to 30 feet have read/write distances of about 100%, and loops from 30 to 100 feet have read/write distances of about 25%.

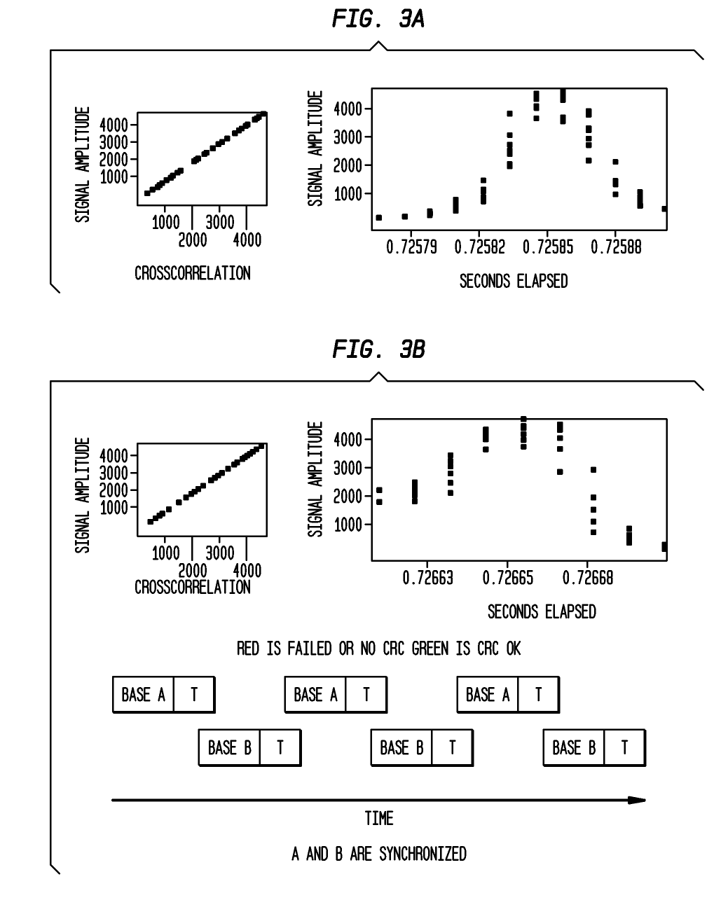

When the Overlap Region impinges on an adjacent RuBee™ network, it is necessary to multiplex tag communication. A single tag may be read at about 8 times/second. Two methods are used for multiplexing adjacent antennas with overlap. The first method simply alternates the two base stations with a token passing scheme (see FIG. 3). Base A broadcasts a packet, passes the token to Base B, and it can talk. However, this cuts read/write times to 4 tags/second, about half for two adjacent antennas, three times for three, etc. A second method is simply to allow two base stations to broadcast randomly; when two packets collide, wait a random period before attempting to re-broadcast. This collision detection approach works well for a limited number of nodes on a network, but slows down dramatically as node number increases. The second collision detection method is often much slower than the first token passing method.

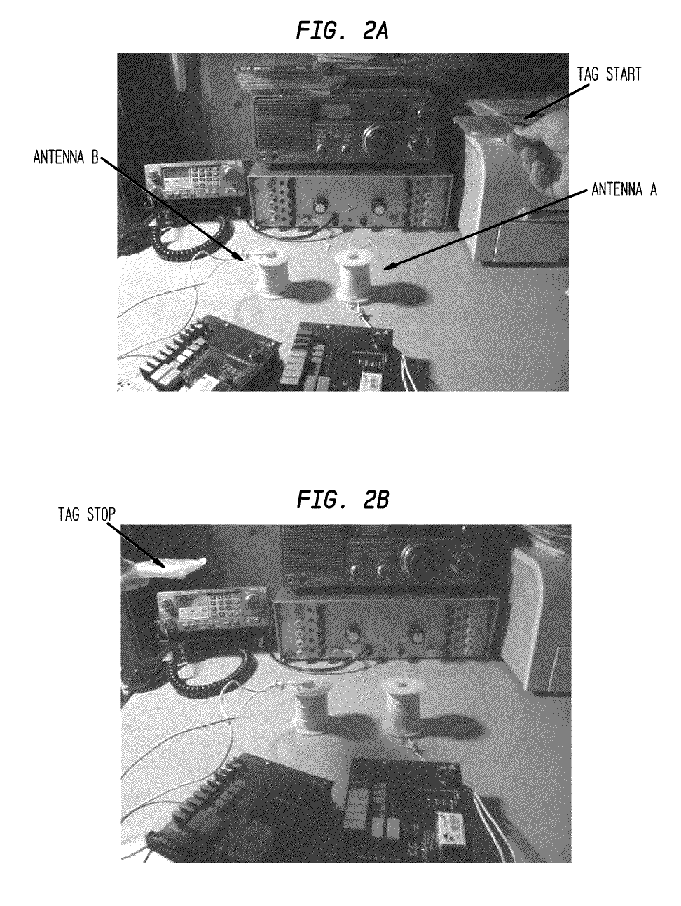

Two Blaster V30 base stations using the TCP/IP protocol and Clip-enabled were connected to two small wound antennas (See FIG. 2). Finder V7.19 was used to collect and log Part11 data. Three conditions were tested:

Token—Two base stations talk when the other is not talking (FIG. 3).

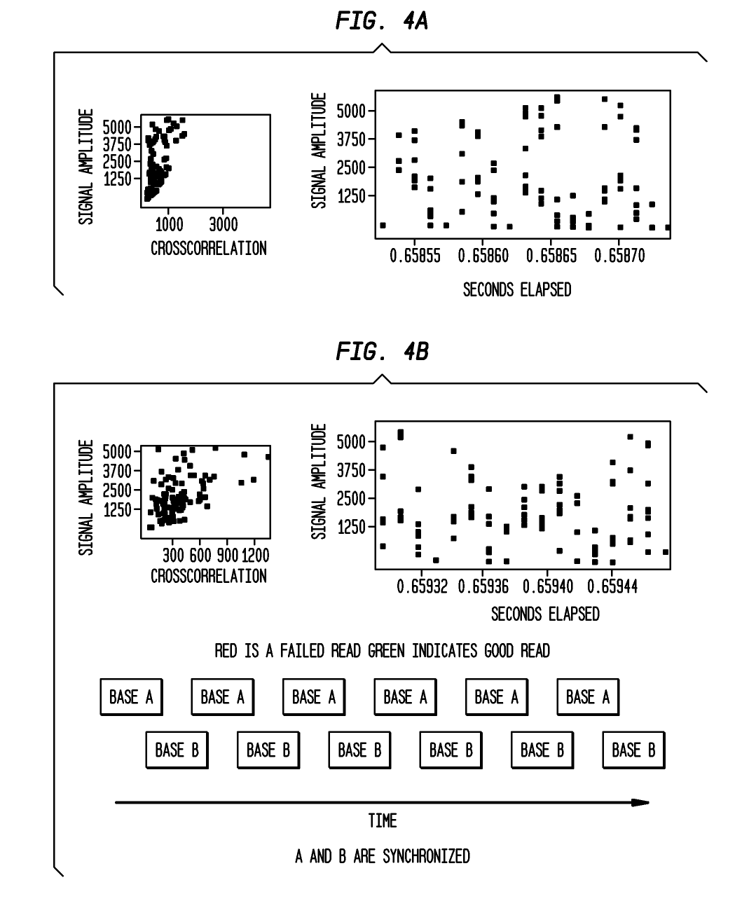

Collision—Two base stations talk randomly (FIG. 4).

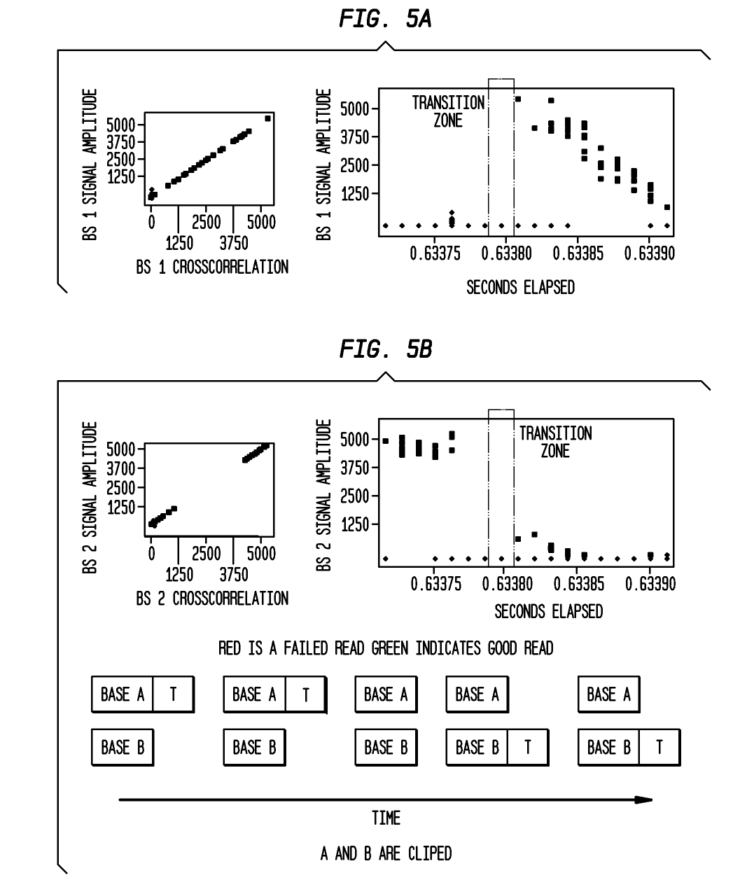

Clip—Two base stations talk, synchronized with each other (FIG. 5).

CSV data files were loaded. Two plots were done for each set (see above). A plot of signal strength vs. analog cross-correlation value for a ping using a known 32 bit “Supper Number” (SN=F9F42BB1) was completed. In each case, the lighter dots represent a successful read and the darker dots are failed reads.

The base station sent out an instruction to the tag and the tag responded with a fixed known SN with an equal number of transitions (0's and 1's). The correlation is carried out on the analog un-processed signal and should be equal to the signal strength if the data is readable. The graph on the above left shows two are linear for nearly all signal strengths. The second graph on the right is a scatter plot of signal strength vs. time as the tag is moved across the field at a constant speed. It essentially plots the field strength of the antenna. The signal amplitude units are arbitrary units that could be translated with calibration into mGauss.

### Results

The same study protocol was used for each of the three conditions: Token, Collision and Clip Synchronization

Token—FIG. 3 shows that the token method works well with 100% reads inside the antennas' field. However, the read rate was 50% of the normal read rate. The cross-correlations are linear, indicating that tags were synchronized and CRC is accurate.

Collision—FIG. 4 shows two base stations unsynchronized and colliding. With collision detection, we would be able to wait and retransmit. In this case, we simply tried to read the tag as it was moved through two fields. Very few successful reads were recorded and the cross-correlations were near random.

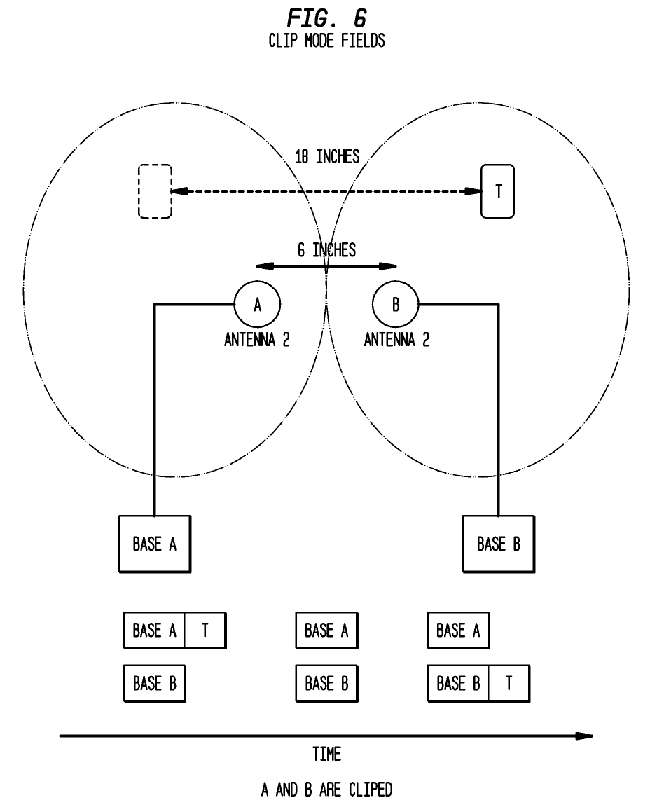

Clip—FIG. 5 shows data from Clip synchronization. It is clear the two correlation graphs are acceptable again, and the two fields have been clipped into separate read/write areas (see FIG. 6). Most importantly, the two base stations were operating at maximum speed (7 tags per second). A few read errors did occur when the tag was in the clipped field of either, probably due to the decrease in signal to noise ratio. However, read rates were acceptable (72% for Antenna A and 80% for Antenna B).

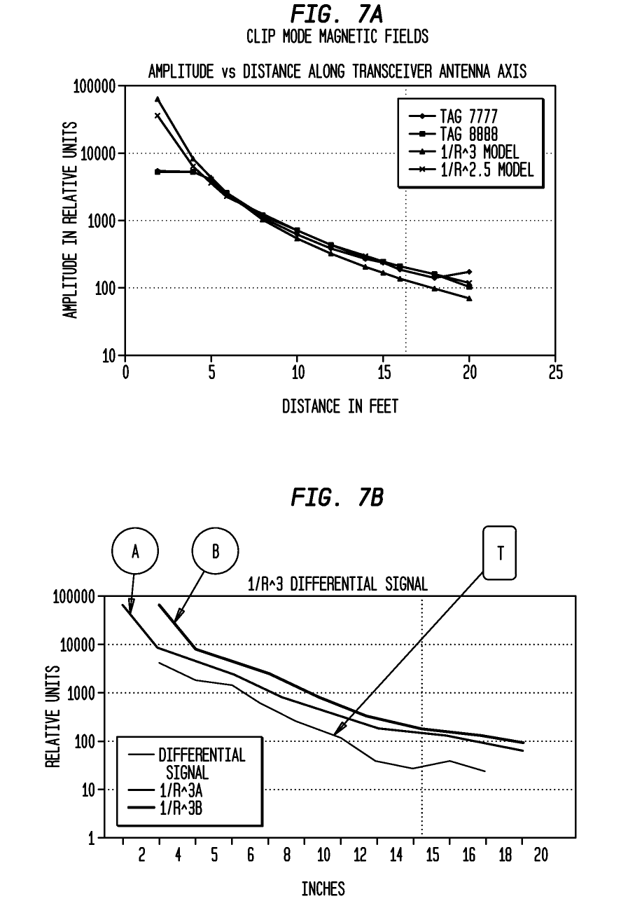

In an inductive near field antenna, the signal strength should drop as 1/R3. We confirm that the signal strength corresponds to the theoretical curve in FIG. 7. The tag signal strength was measured as a function of R (distance X-axis) and the signal was plotted on the Y-axis as a log scale. The data was collected using a Ranger antenna and Blaster V10 (with a range of about 20′) and best-fit curves were calculated. The best-fit curve for data was 1/R^{2.8}, experimentally close to the 1/R³ theoretical value.

The lower graph B in FIG. 7 shows the signal vs. distance curve for antennas used in this study based on 1/R³. A second 1/R³ curve is shown for the second antenna, but it has been shifted by one inch (A and B antennas were actually six inches part). This shift was created as a “worst case” example of what the expected differential signal strength (A−B) might be. This is what a tag might see by a two antenna system. In other words, Base A would appear as noise and Base B (stronger signal) would be seen as data that could be read and synchronized. Thus, differential signal strength plotted in blue represents the expected “clean” signal the tag might see from the nearest antenna.

Clip synchronization clearly provides enhanced throughput and performance over collision detection and token systems. Visibility networks often have many trade-offs in space and bandwidth. High bandwidth over a large area with a limited number of nodes is often not as desirable as an unlimited number of nodes with reduced bandwidth over a smaller area. Clip synchronization has the potential to provide near-unlimited spatial resolution and bandwidth.

### Increased Spatial Bandwidth

FIG. 8 illustrates this trade-off. FIG. 8 shows a linear Clipped RuBee™ antenna farm. Assume 20 tags must be read as part of a physical inventory. Since all five antennas shown in FIG. 8 can operate simultaneously, we can read the tags at an effective rate of 5,000 baud. In addition, each antenna is required to resolve only four tag IPs. Moreover, we obtain spatial location information of the inventory. A single long-range equivalent antenna would have to work at 5,000 baud and have a tougher job resolving 20 tag IPs. If the system were operated in conventional Token or Collision mode, bandwidth would be reduced to below 1,200 baud. Thus, Clipped RuBee™ has the potential to expand both spatial resolution and bandwidth simultaneously.

### 3D Spatial Localization

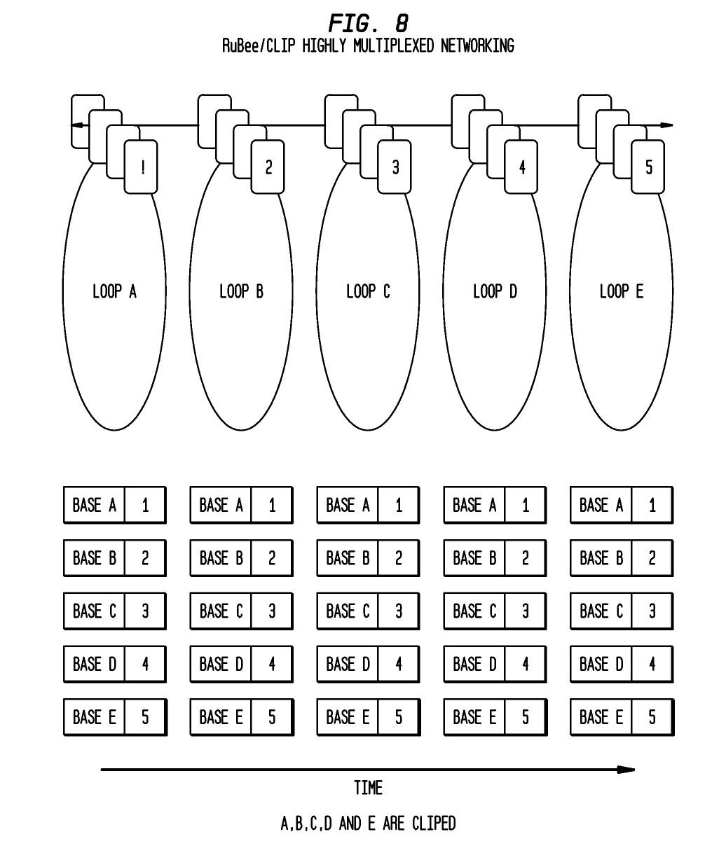

FIG. 9 shows a single tag moving through a Clipped RuBee™ antenna farm is capable of rapid IP address resolution as well as 3D spatial localization. The tag localization may be obtained from the antenna location. However, adjacent antennas can sync and will see the signal from the tag. That signal strength may be used to refine the location data.

### Security and Tempest Issues

FIG. 10 shows another novel application of Clip synchronization. RF-ID tags and radio tags are often banned in high security areas because of the Tempest threat (see document NACSIM 5000 “Tempest Fundamentals,” from the NSA). Simply stated, any intentional or unintentional (e.g., computer) transmitting device may contain useful information or may covertly be converted into a microphone. A high frequency system will produce an electric field signal that drops off as 1/R. Thus, while the range of an RF-ID system in a secure room may appear to be only a few feet, with specialized equipment the emitted radio signal may be detected miles away. RuBee has three clear advantages in these high security applications:

It emits almost no electric field (E in Maxwell's equation). Typical measured field strengths for a base station and loop antenna are 40 nanowatts. The electric field is near undetectable and in the noise at 10-20 meters from a base station. The RuBee™ tags produce a field of about 2-5 nanowatts. The tag electric field is undetectable. Moreover, if necessary, a water jacket placed around the antenna or other EMI shielding material may be used to reduce the E component to zero.

The magnetic field produced by RuBee™ drops off 1/R³ (see FIG. 7). The detectability of the magnetic component (H in Maxwell's equations) from a RuBee™ antenna is limited to 10 meters. At 10 meters it is below the level of background noise from deep space Kilometric type II radio bursts.

Concentric Clipped antennas as shown in FIG. 10 may be used to effectively contain a signal to a small region. The outer antenna system need not have any data charring capacity, only functioning as a carrier during the transmit cycle. It effectively becomes an electronic EMI and EMC shield. The antennas may be contained within a single package and would appear to be limited field antennas.

### How Clip Works

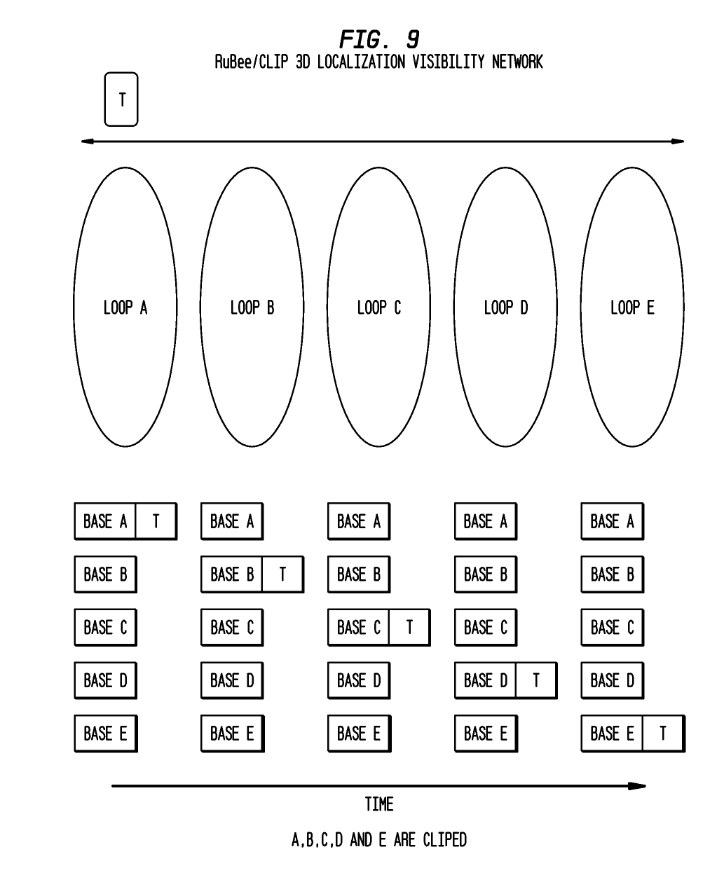

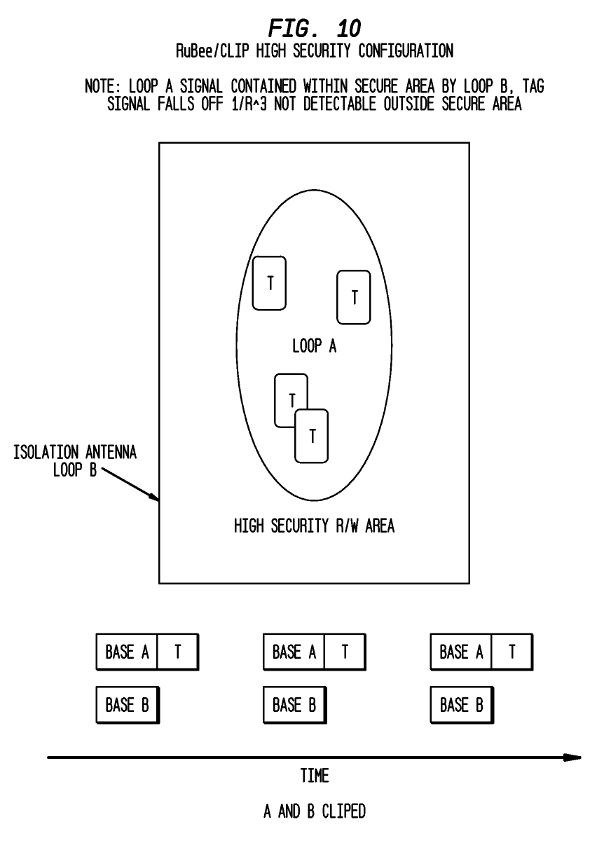

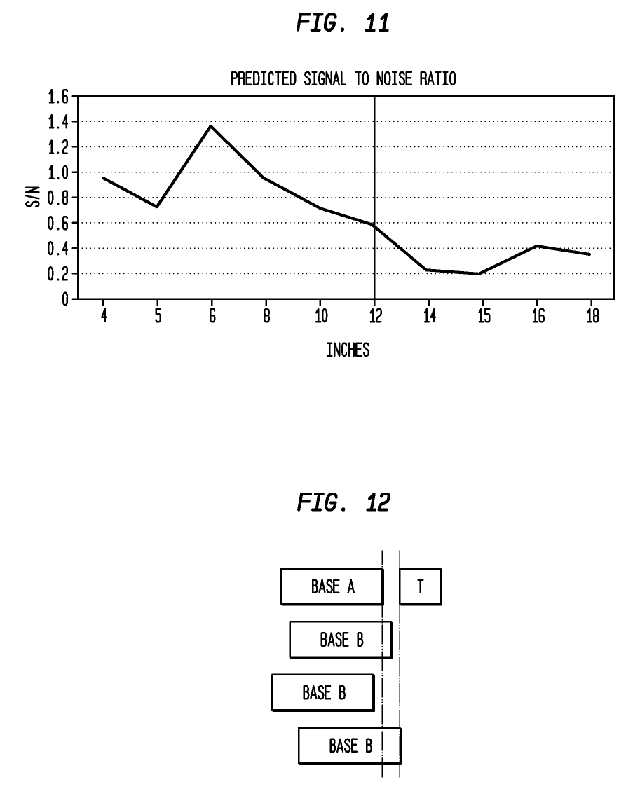

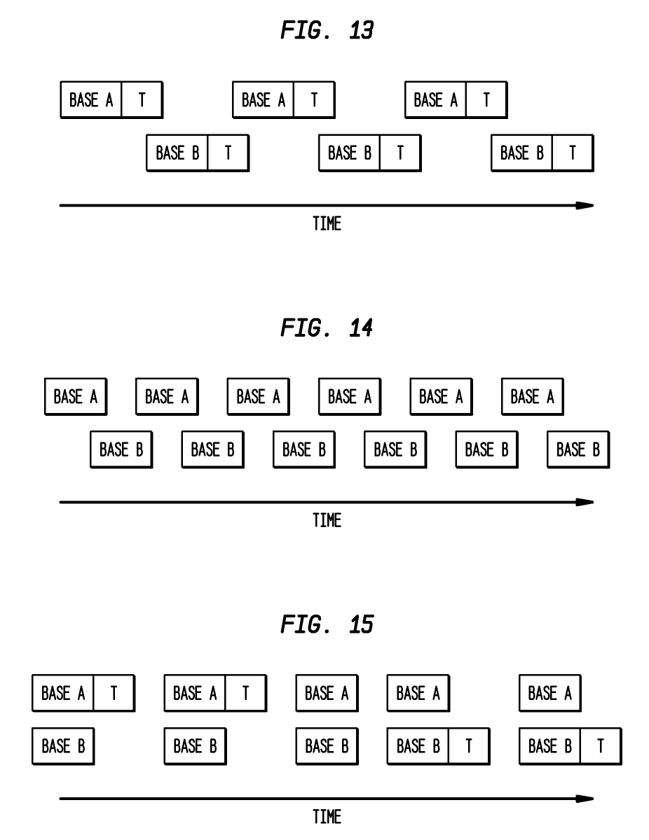

One of the key advantages RuBee™ has over known long wavelength designs is a wide dynamic range amplifier (four decades) located in the tag. That wide dynamic range is essential to read and communicate with base stations over long distances. In an inductive system, the signal strength drops off as 1/R³ (see FIG. 7). The tags require a signal of only about 200 units over the noise to read data. That means the tags can work in a high noise environment where the signal-to-noise ratio may be as low as 1/20 (signal: 1 unit, noise: 20 units or S/N ratio=0.05). Two displaced antennas will produce a signal as shown in FIG. 7B. We have plotted the expected signal-to-noise ratio from the same data as FIG. 11.

The average S/N ratio is 0.65 in FIG. 11, with a minimum of 0.2 and maximum of 1.39. Thus, the tag sees a clear signal from a single base station at a good S/N level. The second, more distant base station is seen as noise. If, on the other hand, a second, more distant base station were transmitting during the time the tag itself was attempting to communicate back to the first base station, the signal would be swamped. The noise level from the adjacent base station and antenna would be much greater than the tag signal level. The S/N ratio is actually negative with no detectable signal.

An important technical issue is accuracy of the synchronization of the two base station transmit signals. If the more distant base station is too well synchronized, or if it were to have a data stream that has the same transitions as data in the signal from the nearby base station, the two signals could sum and lead to data errors. The RuBee™ protocol uses BMP encoding. At 1,200 baud, the transition takes place about every 64 cycles (0.4 microseconds), and 128 cycles per bit (0.8 microseconds) of the 131 kHz carrier. If the two signals are shifted by 10-20 cycles, one will be seen as noise and the second, stronger, nearby antenna will be seen as a synchronized data signal.

Thus, one important feature of Clip synchronization is that the two base stations should not be too well synchronized. In this study, we synchronized using TCP and/or UDP protocols over those of LAN. That leads to a plus or minus few milliseconds. The key is that the distant base station does not have any overlap with the tag reply to the nearby base station's ping (see FIG. 12).

### Conclusions

Clip synchronization has the ability to increase total bandwidth tens of times over other network synchronization protocols for any visibility network and provide location information. Clip leads to highly multiplexed networking. If properly configured, Clip may also have applications for 3D localization via Clip RuBee™ antenna farms. Finally, Clip may be useful in high security applications with minimal tempest threat. Based on data in this study, signals may be limited and blocked from any secure area with additional Clip synchronized antennas.

Therefore, while there has been described what is presently considered to be the preferred embodiment, it will understood by those skilled in the art that other modifications can be made within the spirit of the invention. The above description of an embodiment is not intended to be exhaustive or limiting in scope. The embodiment, as described, was chosen in order to explain the principles of the invention, show its practical application, and enable those with ordinary skill in the art to understand how to make and use the invention. It should be understood that the invention is not limited to the embodiment as described above, but rather should be interpreted within the full meaning and scope of the appended claims.

We claim:

1. A method for providing unlimited multiplexing of network nodes, the method comprising steps of:
placing a plurality of tags within a network node, wherein the tags comprise the RuBee long wavelength network protocol;
clipping the plurality of tags into separate areas for transmitting and receiving, by placing a plurality of base stations within the network node such that at least one base station overlaps with an adjacent network node; and
synchronizing transmit packets from two adjacent base stations transmitting at a same time, such that the tags detect and respond to the packets from a nearby base station and perceive the packets from the distant base station as noise.

2. The method of claim 1 wherein a TCP/IP protocol is used to synchronize the transmit packets.

3. The method of claim 1 wherein a UDP protocol is used to synchronize the transmit packets.

4. The method of claim 1 wherein a combination of the TCP/IP and UDP protocols are used to synchronize the transmit packets.

5. The method of claim 1 further comprising examining the signal strength of the tags for refining location data between adjacent tags.

6. The method of claim 1 wherein the signal strength decreases at 1/R³.

7. The method of claim 1 wherein the tag antennas can be contained within a signal package, acting as limited field antennas.

8. The method of claim 1 wherein the base stations are operating at a transmission speed of seven tags per second.

9. A multiplexed network of nodes comprising:
a plurality of tags placed within a network node, wherein the tags comprise the RuBee long wavelength network protocol;
a plurality of base stations placed such that at least one base station overlaps with an adjacent network node; and
transmit packets synchronized with adjacent base stations.

10. The network of claim 9 wherein the network node comprises a linear configuration.

11. The network of claim 9 wherein the network node comprises a circular configuration.

12. The network of claim 11 wherein the circular configuration comprises concentric circles.

13. The network of claim 9 wherein the nodes are networks of nodes.

14. The network of claim 9 wherein the transmit packets are synchronized using a TCP/IP protocol.

15. The network of claim 9 wherein the transmit packets are synchronized using a UDP protocol.

16. The network of claim 9 wherein the transmit packets are synchronized using a combination of TCP/IP and UDP protocols.
